(19) United States
(12) Patent Application Publication
(10) Pub. No.: US 2013/0311429 A1
(43) Pub. Date: Nov. 21, 2013

(54) METHOD FOR CONTROLLING BACKUP AND RESTORATION, AND STORAGE SYSTEM USING THE SAME

(71) Applicants: Masakuni Agetsuma, Tokyo (JP); Akio Shimada, Kobe (JP); Atsushi Sutoh, Yokohama (JP)

(72) Inventors: Masakuni Agetsuma, Tokyo (JP); Akio Shimada, Kobe (JP); Atsushi Sutoh, Yokohama (JP)

(73) Assignee: HITACHI, LTD., Chiyoda-ku, Tokyo (JP)

(21) Appl. No.: 13/512,489

(22) PCT Filed: May 18, 2012
(86) PCT No.: PCT/JP2012/003279

§ 371 Date: May 29, 2012

(51) Int. Cl. G06F 17/30

(52) U.S. Cl. 707/640; 707/E17.005

(57) ABSTRACT

According to the prior art virtual file backup method, backup is performed without saving a file configuration information, so that the backup file cannot be restored as a virtual file during restoration, and the usage capacity of the disk is increased. According to the present invention, an actual data managed by a virtual file, an actual data managed by one or more element files and a configuration information of the virtual file are respectively stored during backup, wherein during restoration, the virtual file is restored based on the configuration information of the virtual file.

### TECHNICAL FIELD

The present invention relates to a storage system controller, a storage system and a method for controlling backup and restoration in a storage system.

### BACKGROUND ART

A virtual file technique is provided in which a whole or a portion of the actual data of a file is managed via a separate file (hereinafter referred to as “element file”).

A file for managing the actual data of the file by an element file through application of the virtual file technique is called a “virtual file”.

The associated information of the virtual file and the element file (hereinafter referred to as “virtual file configuration information”) is managed by an OS (Operating System).

A virtual file looks just like a common file, and the user applies a common file accessing method to access a virtual file.

The OS performs a process to switch the access request from the user from a virtual file to an element file storing actual data. One example of a virtual file technique is a file cloning technique taught in patent literature 1.

A file cloning technique is a function for managing the actual data of a plurality of files having the same data using an element file called a golden image (GI), and saving only the difference data caused by update of the file in a virtual file to thereby enable efficient use of disks.

### CITATION LIST

### Patent Literature

PTL 1: U.S. Pat. No. 7,409,511

### SUMMARY OF INVENTION

### Technical Problem

If a virtual file technique is used in combination with an existing backup system, the existing backup system will simply back up the virtual file as a normal file without saving the configuration information of the virtual file managed by the OS.

Since the configuration information of the virtual file will be lost if a virtual file is simply backed up as a normal file, the file cannot be restored as a virtual file during restoration processing.

For example, when the file cloning technique is applied, the file cannot be restored as a virtual file during restoration processing, so that the respective files having shared the actual data via the GI will each need to store data, and the capacity of use of the disk will be increased.

### Solution to Problem

According to the present invention, the actual data managed via the virtual file, the actual data managed via the element file and the configuration information of the virtual file are respectively saved during backup, and during restoration, the virtual file is restored using the configuration information of the virtual file.

### Advantageous Effects of Invention

According to the present invention which enables to control the backup and restoration processing of virtual files, an efficient use of disks is realized.

### BRIEF DESCRIPTION OF DRAWINGS

FIG. 1 is a block diagram illustrating a configuration example of a computer system according to the present embodiment.

FIG. 2 is a block diagram illustrating a hardware configuration of a unified storage system according to the present embodiment.

FIG. 3 is a block diagram illustrating a hardware configuration of a management computer according to the present invention.

FIG. 4 is a software configuration of a storage head according to the present embodiment.

FIG. 5 is a schematic diagram illustrating an outline of the present embodiment.

FIG. 6 is a configuration example of a metadata management table according to the present embodiment.

FIG. 7 is a backup example of a metadata management table according to the present embodiment.

FIG. 8 is a configuration example of a virtual file configuration information according to the present embodiment.

FIG. 9 is a backup example of a virtual file configuration information according to the present embodiment.

FIG. 10 is a flowchart of a backup processing according to the present embodiment.

FIG. 11 is a flowchart of a restoration processing according to the present embodiment.

FIG. 12 is a schematic diagram illustrating an outline of a second embodiment.

FIG. 13 is a configuration example of a metadata management table according to the second embodiment.

FIG. 14 is a backup example of a metadata management table according to the second embodiment.

FIG. 15 is a configuration example of a virtual file configuration information according to the second embodiment.

FIG. 16 is a backup example of a virtual file configuration information according to the second embodiment.

### DESCRIPTION OF EMBODIMENTS

Now, the preferred embodiments of the present invention will be described with reference to the drawings. For sake of better understanding, the following description and the accompanying drawings are arbitrarily abbreviated or simplified. The present invention is not restricted by the present embodiments, and other modified examples in conformity with the idea of the present invention are included in the technical range of the present invention. The number of each component can be one or more than one unless defined otherwise.

In the following description, various information are referred to as “table” and the like, but the various information can be expressed by data structures other than tables. Further, the “table” can also be referred to as “information” to show that the information does not depend on the data structure.

A management system can be composed of one or a plurality of computers. For example, if a management computer is set to process and display information, then the management computer will function as the management system. If a plurality of computers realize a similar function as a management computer, the plurality of computers (which may include a displaying computer if a displaying computer is used to perform display) will function as the management system. In the present embodiment, the management computer will be the management system.

The processes are sometimes described using the term “program” as the subject, but since the program is executed by a processor (such as a CPU (Central Processing Unit)) for performing determined processes using appropriate storage resources (such as memories) and communication interface devices (such as communication ports), so that a processor can also be the subject of the processes. The processor operates as a functioning unit for realizing a predetermined function by being operated according to a program. The device and system including the processor is a device and system including these functioning units.

The processes illustrated having the program or the processor as subject can also be described using a computer (such as a unified storage system, a management computer, a client or a host) as the subject. The processor can include a hardware circuit performing a portion or all of the processes performed by the processor. The computer program can be installed to each computer from a program source. The program source can be provided via a program distribution server (such as a management computer) or a storage media, for example.

### Embodiment 1

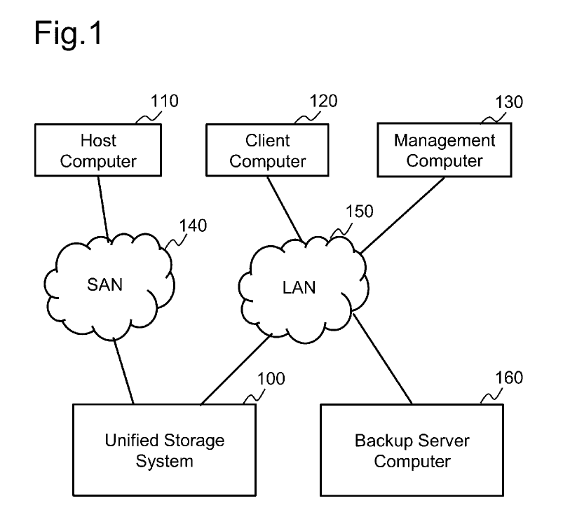

FIG. 1 is a block diagram illustrating a configuration example of a computer system according to the present embodiment. A computer system is composed of a unified storage system 100, a host computer 110, a client computer 120, a management computer 130, a SAN (Storage Area Network) 140, a LAN (Local Area Network) 150, and a backup server computer 160.

The unified storage system 100 is coupled to one or more host computers (hereinafter referred to as host) 110 via a SAN 140. Further, the unified storage system 100 is coupled to one or more client computers (hereinafter referred to as client) 120, one or more management computers 130 and one or more backup server computers (hereinafter referred to as backup server) 160 via a LAN 150.

The unified storage system 100 is a storage system capable of processing a plurality of data communication protocols. For example, the unified storage system 100 uses a communication protocol providing block volumes such as a FC (Fiber Channel), an iSCSI (Internet Small Computer System Interface) or an FCoE (Fiber Channel over Ethernet (Registered Trademark)) to communicate data with the host 110 or the client 120.

Further, the unified storage system 100 uses a communication protocol providing file sharing services such as an NFS (Network File System), a CIFS (Common Internet File System), an FTP (File Transfer Protocol) and an HTTP (Hyper Text Transfer Protocol) to communicate data with the host 110 or the client 120.

The unified storage system 100 receives an I/O request to a block volume from a host 110 via the SAN 140, and returns the processing result to the host 110. The unified storage system 100 receives an I/O request to a file sharing service from the client 120 via the LAN 150, and returns the processing result to the client 120. The unified storage system 100 receives an instruction from the management computer 130 and changes the settings of the unified storage system 100.

The unified storage system 100 creates a backup of the data stored in the unified storage system 100 via the LAN 150 to a backup server 160. The unified storage system 100 performs backup when instructed from the management computer 130 or periodically, for example.

The unified storage system 100 restores the backup data stored in the backup server 160 via the LAN 150 to the unified storage system 100. The unified storage system 100 performs restoration when an instruction is received from the management computer 130, for example.

The unified storage system 100 can be coupled to a plurality of SANs 140 or a plurality of LANs 150. Moreover, the unified storage system 100 can also be coupled to only either the SAN 140 or the LAN 150. Furthermore, the client 120, the management computer 130 and the backup server 160 can be coupled to the unified storage system 100 via different LANs 150. Further, the unified storage system 100 can be coupled via a SAN to the management computer 130 or the backup server 160. Further, the SAN 140 or the LAN 150 can be other types of communication networks, such as a WAN (Wide Area Network) or the internet. Further, the unified storage system 100 had been used according to the present invention, but the present invention is not restricted thereto. For example, a block storage can be adopted if the system is only composed of a SAN 140, and a file storage such as a NAS (Network Attached Storage) can be used if the system is only composed of a LAN 150.

The backup server 160 can include, as storage media, semiconductor media such as an SSD (Solid State Drive), a HDD (Hard Disk Drive), a tape archive, an optical disk library, or a storage device having combined a plurality of storage media. If a tape archive or an optical disk library is used, the backup time or the restoration time may become longer compared to when an SSD or a HDD is used, but the bit cost can be reduced.

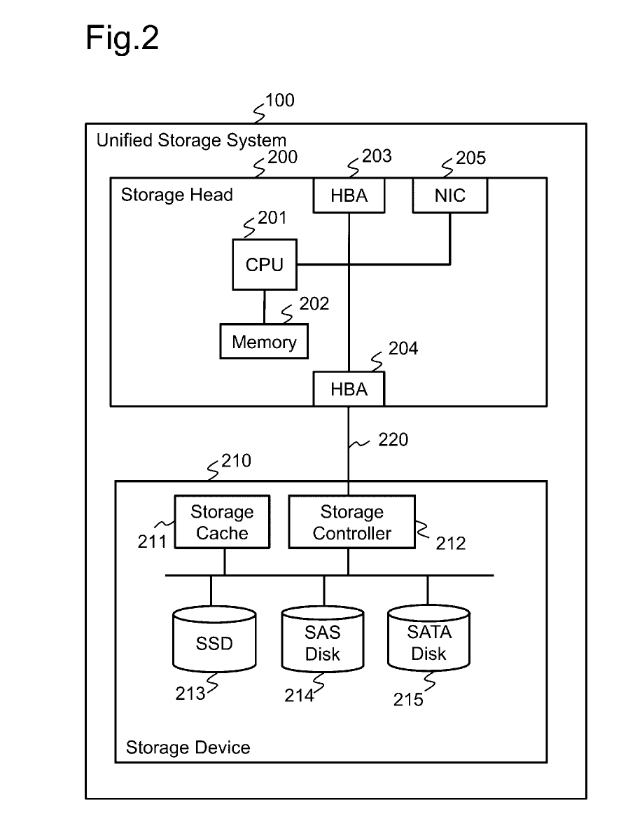

FIG. 2 is a block diagram illustrating a hardware configuration example of a unified storage system 100. The unified storage system 100 can include a storage head 200 and a storage device 210. The storage head 200 and the storage device 210 are coupled via a communication path 220.

The storage head 200 performs management and control of the unified storage system 100 and the storage device 210. The storage head 200 comprises a memory 202, HBA (Host Bus Adaptor) 203 and HBA 204, an NIC (Network Interface Card) 205 and a CPU 201 which is a control arithmetic unit coupled thereto.

A different type of storage resource can be adopted instead of or in addition to the memory 202. Different types of communication interface devices can be adopted instead of the HBAs 203 and 204 or the NIC 205. The HBA 203 is coupled to the SAN 140. The HBA 204 is coupled to the storage device 210 via a communication path 220. The NIC 205 is coupled to the LAN 150.

The CPU 201 executes a computer program stored in the memory 202. The memory 202 stores computer programs and other data. Further, the memory 202 can include a cache area for temporarily storing the data received from the host 110 and the data transmitted to the host 110. The memory 202 can include a cache area for temporarily storing the file received from the client 120 or the file transmitted to the client 120.

The storage device 210 is a storage device for storing the programs and files to be used by the storage head 200. The storage device 210 includes a storage cache 211, a storage controller 212, an SSD (Solid State Drive) 213, a SAS (Serial Attached SCSI) disk 214, and a SATA (Serial ATA) disk 215. The respective components are coupled via an internal bus or an internal network.

The number of the storage cache 211, the storage controller 212, the SSD 213, the SAS disk 214 and the SATA disk 215 is not restricted to the number shown in FIG. 2. Further, the number of the storage device 210 is not restricted to the number shown in FIG. 2. In the following description, the SSD 213, the SAS disk 214 and the SATA disk 215 are collectively called a disk device.

The storage controller 212 communicates with the storage head 200 and controls the storage device 210. Actually, the storage controller 212 communicates with the storage head 200, and based on the request from the storage head 200, writes data into the disk device using the storage cache 211 described later or reads data from the disk device using the storage cache 211.

As described earlier, according to the present embodiment, the access request received by the storage controller 212 or the data transmitted thereto is a block data (sometimes simply called block) designated by a block address format.

For example, the storage cache 211 is a semiconductor memory, which is used to temporarily store the data read into the disk device or the block data read from the disk device. Further, a storage device having a lower speed than the semiconductor memory can be used as a portion of the storage cache 211.

The disk device is a device for storing data. In FIG. 2, the storage device 210 includes a single SSD 213, a single SAS disk 214 and a single SATA disk 215, but an arbitrary number of disk devices can be disposed in the storage device 210. Typical examples of the disk device include the SSD 213, the SAS disk 214 and the SATA disk 215, but any device can be used as long as the device can store block format data, so that for example, the device can use a DVD, a CD or a magnetic tape as the storage media.

From the viewpoint of enhancing speed, realizing redundancy and improving reliability, for example, the storage controller 212 can provide a plurality of disk devices as one or more accessible virtual disk devices to the storage head 200 (more practically, by applying a RAID technology).

In the following description, the virtual disk device is called a volume, and the description stating that “the storage device or the storage controller writes block data into the volume” actually means that the storage controller 212 writes block data into the storage cache 211 or the disk device.

Similarly, the description stating that “the storage device or the storage controller reads block data from the volume” actually means that the storage controller 212 reads block data from the storage cache 211 or the disk device.

Generally, when a request to write data into the volume is received from the storage head 200, the storage controller 212 temporarily writes data into the storage cache 211 having a high access speed, and notifies write complete to the storage head 200.

Then, the storage controller 212 writes data stored in the storage cache 211 to the disk device asynchronously as the write request from the storage head 200 so as to enhance the performance of the storage device 210 as a whole even when the performance of the disk device is low compared to the storage cache 211.

The communication path 220 between the HBA 204 of the storage head 200 and the storage controller 212 of the storage device 210 can be connected via a switch. There can be multiple storage heads 200 and multiple storage devices 210. Further, an arrangement can be adopted in which a plurality of storage heads 200 are coupled to a single storage device 210. The plurality of storage heads 200 and the plurality of storage devices 210 can constitute a SAN.

The communication path 220 between the HBA 204 and the storage device 210 can be composed, for example, of a fiber channel (FC). Other types of networks (such as an Ethernet (Registered Trademark)) can be adopted as the communication path 220 as long as communication is enabled.

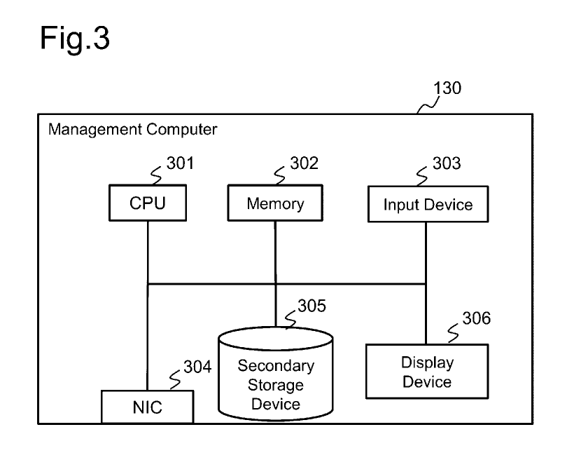

FIG. 3 is a block diagram illustrating a hardware configuration example of a management computer 130. The management computer 130 comprises a memory 302, an input device 303, an NIC 304, a secondary storage device 305, a display device 306 and a CPU 301 coupled thereto. A different type of storage resource can be adopted in place of at least either the memory 302 or the secondary storage device 305. A different type of communication interface device can be adopted in place of the NIC 304.

A computer program is loaded to the memory 302 from the secondary storage device 305. The CPU 301 executes the computer program stored in the memory 302. The input device 303 is a device operated by the administrator, which can be a keyboard and a pointing device, for example. The NIC 304 is coupled to the LAN 150. The secondary storage device 305 can be an HDD, for example. The display device 306 can be a liquid crystal display, for example.

Based on the operation of the administrator, the management computer 130 can set up information in the unified storage system 100, output an instruction to create a virtual file, output an instruction to back up the data in the unified storage system 100 to the backup server 160, and output an instruction to restore data from the backup server 160 to the unified storage system 100.

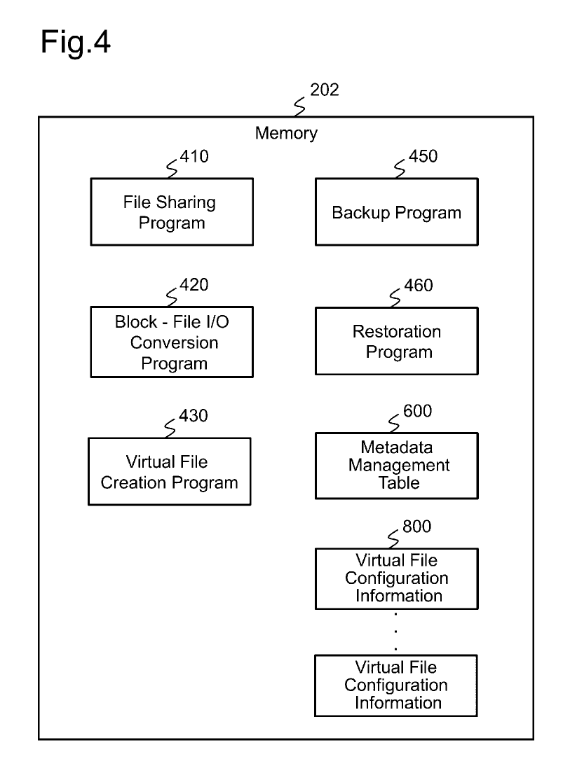

FIG. 4 shows a software configuration example of the storage head 200. The software of the storage head 200 includes a file sharing program 410, a block-file I/O conversion program 420, a virtual file creation program 430, a backup program 450, a restoration program 460, a metadata management table 600, and a virtual file configuration information 800. These software are loaded from a nonvolatile memory device to the memory 202 and stored therein.

The file sharing program 410 provides a file sharing service to the client 120 using communication protocols (NFS/CIFS/FTP/HTTP) and the like.

The block-file I/O conversion program 420 provides a block volume to the host 110 using communication protocols (FC/FCoE/iSCSI) and the like. Moreover, the block-file I/O conversion program 420 converts the I/O request of a block volume received from the host 110 to an I/O request of a file.

The block-file I/O conversion program 420 provides a specific file managed by the unified storage system 100 as if it were a block volume to the host 110. In the following description, a file provided as a block volume is referred to as a block volume file.

The virtual file creation program 430 performs a process to create a virtual file. As an example of creating a virtual file, for example, according to a file cloning function, a specific element file (GI) managing actual data is designated to create a file. The virtual file creation program creates the virtual file as an empty file having a pointer to the designated element file as the virtual file configuration information 800. A file cloning function for creating a virtual file from a single element file has been illustrated as an example, but the virtual file creation program 430 is not restricted to such example. For example, it is possible to create a virtual file for managing an actual data using multiple element files.

The backup program 450 performs a process to back up the metadata and the data of the virtual file, the metadata and the data of the element file, and the virtual file configuration information 800 managed by the OS to the backup server 160. Prior to creating a backup in the backup server 160, the backup program 450 performs a process to rewrite the management information unique to the unified storage system 100 in the virtual file configuration information 800 to the management information of the backup server 160.

The restoration program 460 performs a process to restore the backup data as a virtual file based on the virtual file configuration information 800 or the metadata and the data of the virtual file or the metadata and the data of the element file saved in the backup server 160. The restoration program 460 performs a process to rewrite the virtual file configuration information during restoration from the management information of the backup server 160 to the management information of the unified storage system 100.

The metadata management table 600 is a table for managing the metadata of the file system stored in the unified storage system 100. The table 600 will be described in detail later.

The virtual file configuration information 800 is a table for managing the configuration information of the virtual file (information of the element file constituting the virtual file) stored in the unified storage system 100. A single virtual file configuration information 800 is created to correspond to each virtual file. The virtual file configuration information 800 will be described in detail later.

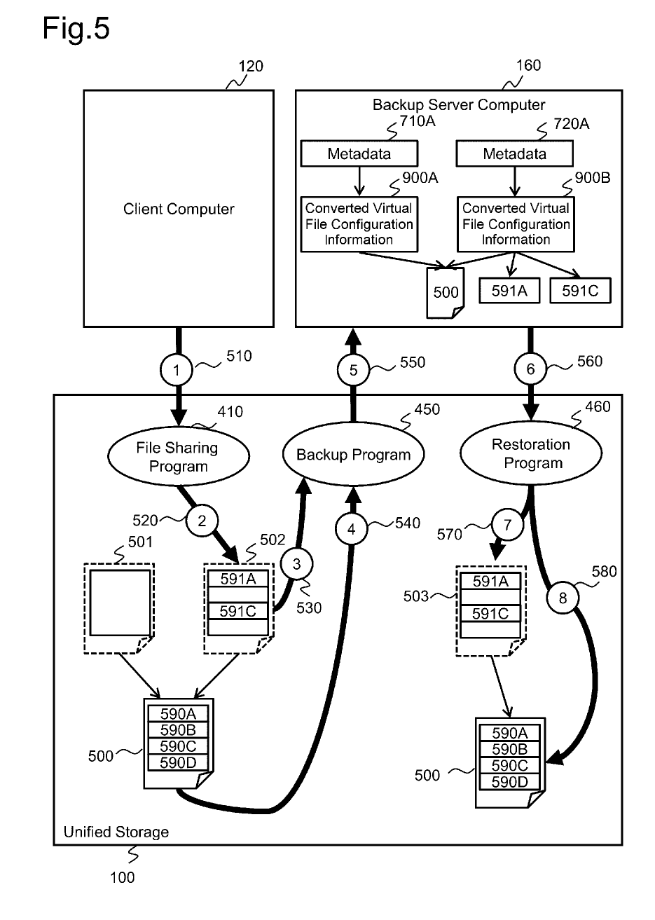

FIG. 5 is a schematic diagram illustrating the outline of the present invention. FIG. 5 illustrates an outline of backup and restoration of virtual files 501 and 502 shared via the file sharing program 410. Now, the virtual file 501 is a virtual file created by setting the file 500 as the element file via the file cloning function. Similarly, the virtual file 502 is also a virtual file created by setting the file 500 as the element file via the file cloning function.

In the file 500, actual data is managed via four data areas (referred to as extents hereafter) 590A, 590B, 590C and 590D. Since the virtual file 501 does not have difference data, it refers to the element file 500 as the location of actual data. On the other hand, the virtual file 502 has data updated, wherein the two extents, extent 591A having updated extent 590A and extent 591C having updated extent 590C, are managed as difference data.

Now, the flow of performing backup and restoration based on the I/O to the virtual file 502 will be described below with reference to FIG. 5.

(1) If an I/O request using a file-level communication protocol (NFS/CIFS/FTP/HTTP) and the like is generated from the client, the I/O request is received by the file sharing program 410 (510).

(2) Based on the I/O request from the client 120, the file sharing program 410 performs an I/O processing of the virtual file 502 in the file system. If the request is a read request of an area in extent 590B, a process to read data from the extent 590B of the element file 500 is performed. If the request is a write request of an area in extent 590A, an extent 591A is created as difference data without updating the extent 590A in the element file 500, and stored in the virtual file 502 (520).

(3) The backup program 450 periodically monitors the metadata (such as file name, file size, owner and access control information) and update of data of the virtual files 501 and 502. When update is detected, the backup program 450 acquires the metadata and the difference data of the virtual files 501 and 502. Moreover, the backup program acquires the virtual file configuration information 800 managed by the unified storage system 100. In the present description, it is assumed that the virtual file 502 has been updated and has become the target of backup (530).

(4) The backup program 450 periodically monitors the update of data of the element file 500. When update of data is detected, the backup program 450 acquires data of the updated element file. However, FIG. 5 illustrates an example in which the updated data is stored in the virtual file 502, so that the element file will not be updated. The element file is only initially subjected to backup and will not be subjected to further backup, since it is not updated (540).

(5) The backup program 450 performs backup of the metadata and the difference data of the virtual file 502 acquired in (3) (such as the extent 591A and extent 591C in FIG. 5), the virtual file configuration information 800, and the element file 500 acquired in (4). At this time, the management information specific to the unified storage system 100 (such as the inode number) in the metadata and the virtual file configuration information 800 acquired in (3) are converted to the management information of the backup server 160 (such as the UUID (Universally Unique Identifier), and backup of the converted metadata and virtual file configuration information (converted virtual file configuration information) are performed (550).

In the backup server 160 of FIG. 5, the metadata 720A and the converted virtual file configuration information 900B of the virtual file 502 are associated and saved, and pointers to actual data of the virtual file (element file 500, difference data 591A and 591C) are stored as UUID in the virtual file configuration information 900B.

(6) When a restoration instruction is received via the management computer 130 and the like, the restoration program 460 performs a reading process of metadata or converted virtual file configuration information of the restoration target file from the backup server 160. In the present example, it is assumed that the management computer 130 has instructed restoration of the virtual file 502. The restoration program 460 reads the metadata 720A and the virtual file configuration information 900B of the virtual file 502 (560).

(7) The restoration program 460 restores an empty file in which only metadata is set as the virtual file 503 using the metadata 720A of the virtual file 502. In the actual restoration process, the management identifier UUID of the metadata acquired in (6) is rewritten to the management information (inode number) specific to the unified storage system 100, and stored in the memory 202 of the unified storage system 100 (570).

(8) The restoration program 460 downloads actual data (element file 500 and difference data 591A and 591C) from the backup server 160 using the UUID stored in the virtual file configuration information acquired in (6) as the key, and instructs a restoration process of the corresponding relationship of the virtual file 503 and the element file 500 to the unified storage system 100. In the actual restoration process, the UUID of the virtual file configuration information acquired in (7) is rewritten as the management information (inode number) unique to the unified storage system 100, and stored in the memory 202 of the unified storage system 100 (580).

In (2), the difference data is stored in the virtual file 502 as extent 591A without directly updating the extent 590A of the element file 500, but the method for updating data is not restricted thereto. For example, the extent 590A in the element file can be directly updated. In that case, the virtual file 501 referring to the same element file will be influenced thereby.

In (3) and (4), the backup program 450 periodically monitors the element file and the virtual file to detect update, but the method for detecting update is not restricted thereto. For example, the file sharing program 410 can sent a notice to the backup program 450 when the file sharing program 410 updates a virtual file.

In (8), the restoration program 460 adopts a method to read the data of the element file 500 and the difference data 591A and 591C of the virtual file all at once to perform restoration, but the restoration method is not restricted thereto. For example, a method can be adopted in which the data to be restored is not read all at once, but only the data of necessary sections are read to perform restoration based on the I/O request from the user to the virtual file (On Demand Restore).

In FIG. 5, the I/O request from the client 120 using a file-level communication protocol such as NFS/CIFS/FTP/HTTP and the like is received by the file sharing program 410, which is then converted to the I/O of the file within the unified storage system 100, but the method of performing I/O of the unified storage system 100 is not restricted thereto. For example, it is possible that the I/O request using a block-level communication protocol such as FC/FCoE/iSCSI and the like can be received by the block-file I/O conversion program 420 instead of the file sharing program 410, and the I/O can be converted to the I/O of the file stored in the unified storage system 100.

As described in (1) through (8), the backup data can be restored as a virtual file by saving the virtual file configuration information during backup of a virtual file.

According to the schematic diagram of FIG. 5, the transfer destination of the backup program 450 is the backup server 160 disposed outside the unified storage system 100, but the present invention is not restricted to such example. For example, the backup server 160 can be disposed within the unified storage system 100.

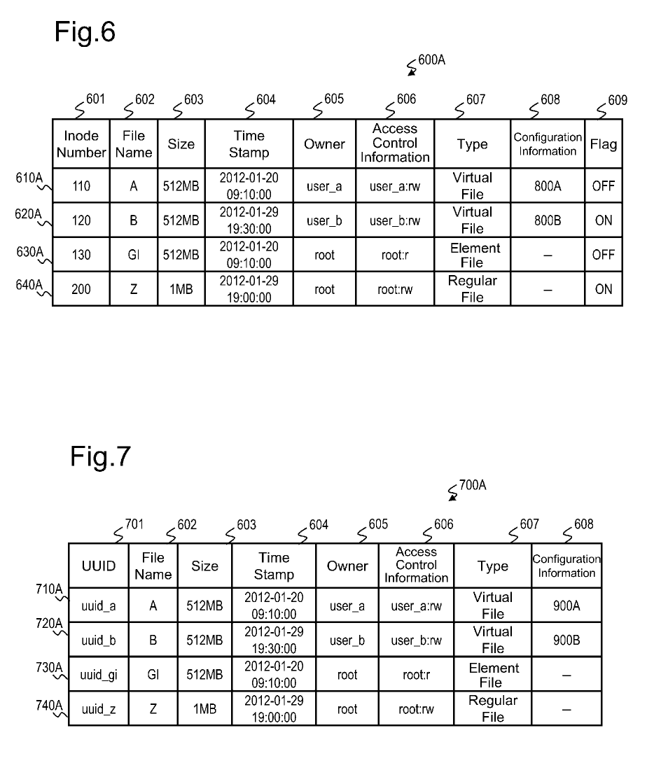

Now, the present embodiment will be illustrated in detail. FIG. 6 is a configuration example 600A of a metadata management table 600. Each row of the metadata management table 600A corresponds to a the metadata of each file, and the table includes an inode number 601 of the file, a file name 602, a file size 603, a time stamp 604, an owner 605, an access control information 606, a type 607, a configuration information 608 and the update flag 609.

An inode number 601 denotes a unique number assigned to each file within the file system. A file name 602 refers to a name of each file within the file system. A size refers to the file size. The file consumes blocks of a volume provided by the storage device 210 based on the size 603.

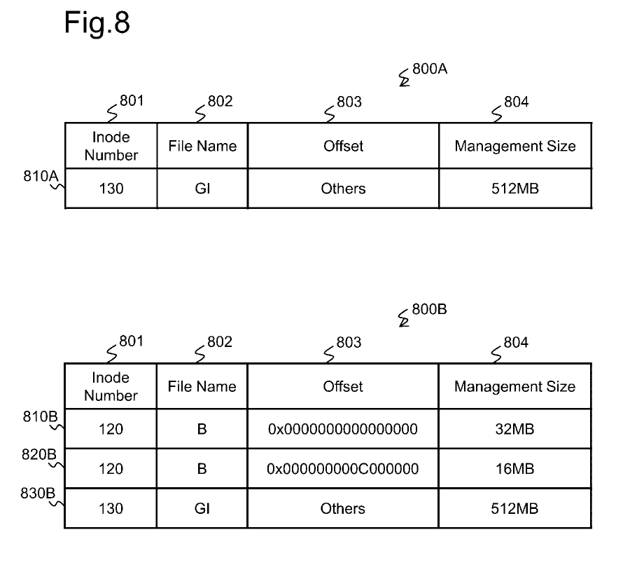

A time stamp 604 shows the time of update of the file. Upon processing an I/O of a file, the file sharing program 410 overwrites the time in which I/O processing of the file has been performed in the time stamp 604. An owner 605 refers to the owner of the file. An access control information 606 refers to the access control information of the file. The access control information 606 is used only when a specific user is enabled to access the file. It is sometimes also called a permission, or an ACL (Access Control List) which enables a more advanced access control than permission. A type 607 shows whether the file is a virtual file, an element file or a normal file (regular file). In the case of a virtual file, the configuration information 608 stores a storage location information of the virtual file configuration information 800 illustrated in FIG. 8. An update flag 609 is set to on immediately after a file has been newly created or when writing of data occurs to the file. The flag is set to off when the file has been subjected to backup.

For example, first row 610A of the metadata management table 600A shows the metadata of file “A”. It shows that the inode number of file “A” is “110”, the file name is “A”, the size is “512 MB”, the time stamp is “January 20, 2012, 09:10:00”, the owner is “user_a”, the access control information is “only user_a authorized to read/write”, the file type is “virtual file”, the configuration information of the virtual file is stored in “800A”, and the update flag 609 is not set to on (OFF). Rows 620A and 630A are set in a similar manner Further, 610A corresponds to the metadata of the virtual file 501 of FIG. 5, 620A corresponds to the metadata of the virtual file 502 of FIGS. 5, and 630A corresponds to the metadata of the element file 500 of FIG. 5.

FIG. 7 shows a converted metadata management table 700A having converted the metadata management table 600A and backed up in the backup server 160. The metadata management table 700A includes a UUID 701, a file name 602, a file size 603, a time stamp 604, an owner 605, an access control information 606, a type 607 and a configuration information 608.

The file name 602, the file size 603, the time stamp 604, the owner 605, the access control information 606 and the type 607 will not be described here since they were already described with reference to FIG. 6. The UUID 701 is an identifier for uniquely managing the unit of backup data (such as files and objects) within the backup server 160. In the first row 710A of the converted metadata management table 700A, “uuid_a” as UUID is retained instead of the maintenance information inode number unique to the unified storage retained in 600A. The configuration information 608 stores a storage location information of the virtual file configuration information retained in the backup server 160. The rows 720A and 730A are set similarly.

In the present embodiment, for simplification, the information retained in UUID 701 is shown as “uuid_a”, but generally, the UUID is represented via a numeric value of 16 bytes, which is in a format such as “494a770b-ea9f-43de-b5a7-6bc9e7aae324”.

Further according to the present embodiment, the identifier for managing data within the backup server 160 is UUID, but other identifiers can be used. For example, the identifier can use random numbers unique within the backup server 160, sequential numbers and save time information.

FIG. 8 shows configuration examples 800A and 800B of a virtual file configuration information 800 managed by the unified storage system 100. The configuration example 800A shows an example of a virtual file configuration information corresponding to a virtual file A (610A) managed via the metadata management table 600A. Further, the configuration example 800B is an example of a virtual file configuration information corresponding to a virtual file B (620A). Each row of the virtual file configuration information 800 corresponds to each element file storing actual data, which includes an inode number 801, a file name 802, an offset 803 and a management size 804 of the element file.

The inode number 801 represents a number uniquely assigned to each file within the file system. The file name 802 represents a name of the file within the file system. The offset 803 shows a start position of the data area in the virtual file managed by the element file. The management size 804 is a size of the data area assigned to the element file with the offset 803 set as the start position. The row in which “others” is entered as offset 803 refers to a particular element file. It means that the element file is an element file (corresponding to GI in a file cloning function) in charge of all remaining areas when there are no other conformable rows (element file in charge of the area indicated by the offset 803 and the management size 804) as the target of I/O processing.

For example, according to the virtual file configuration information 800A of virtual file A, the virtual file A has a single element file “GI”, and when an I/O occurs to the virtual file A, the target of the I/O will be the element file “GI”. Furthermore, according to the virtual file configuration information 800B of virtual file B, the virtual file B manages the actual data via two element files “B” and “GI”. The element file B is the virtual file B itself, and manages difference data.

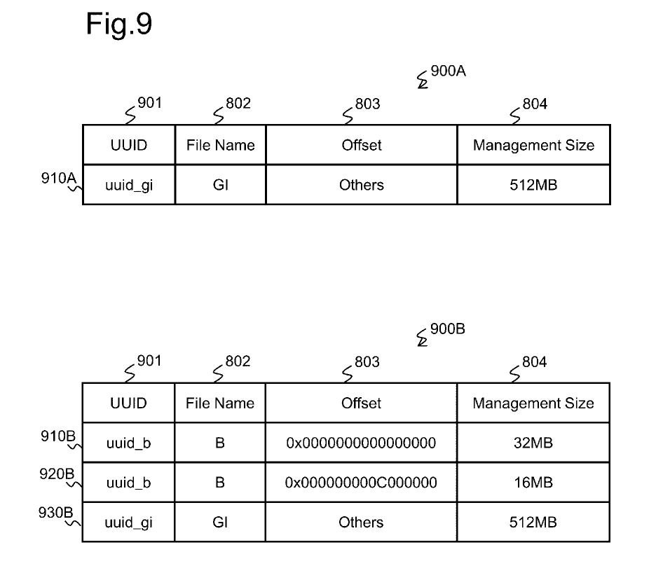

FIG. 9 shows converted virtual file configuration information 900A and 900B having converted virtual file configuration information 800A and 800B and subjecting the same to backup in the backup server 160. The converted virtual file configuration information 900A is the converted virtual file configuration information corresponding to virtual file A (710A). Further, the converted virtual file configuration information 900B is the converted virtual file configuration information corresponding to virtual file B (720A). The converted virtual file configuration information 900 includes an UUID 901, a file name 802, an offset 803 and a management size 804.

The file name 802, the offset 803 and the management size 804 will not be described here since they have already been described with reference to FIG. 8. The UUID 901 is an ID for uniquely managing the unit of backup data (files and objects) within the backup server 160. In the first row 910A of the converted virtual file configuration information 900A, a “uuid_gi” is retained as UUID instead of the management information inode number unique to the unified storage retained in 800A. Similarly, in the converted virtual file configuration information 900B, the first row 910B and the second row 920B retain “uuid_b” and the third row 930B retains “uuid_gi”.

In the present embodiment, UUID has been used for managing backup data in the backup server 160, but the method for managing backup data is not restricted thereto. For example, the backup data can be managed via random numbers, sequence numbers or identifiers using save time information or the like which is unique within the backup server 160.

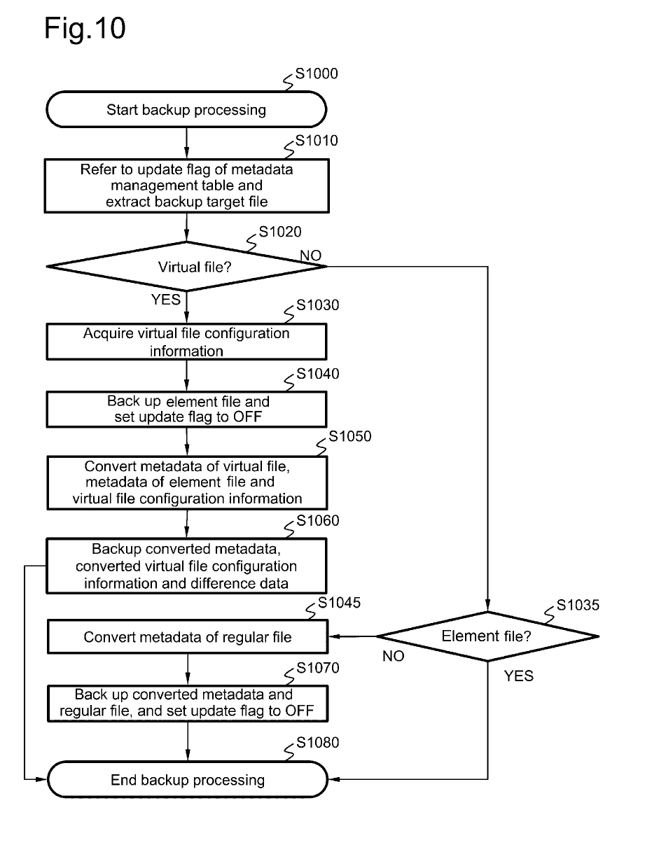

FIG. 10 shows a flowchart of the backup processing. The backup program 450 starts backup processing either periodically or when an instruction from a management computer 130 is received (S1000).

The backup program 450 refers to an update flag 609 managed via the metadata management table 600, extracts a file in which update has occurred (file having the update flag 609 is set to on), and sets the file as target of backup (S1010). The backup program 450 refers to the type 607 of the metadata management table 600, and determines whether the backup target file is a virtual file or not (S1020).

If the result of determination of step S1020 is negative (the backup target is not a virtual file) (S1020: No), the backup program 450refers to the type 607 in the metadata management table 600, and determines whether the backup target file is an element file or not (S1035).

If the result of the determination of step S1035 is positive (the backup target is the element file) (S1035: Yes), the backup program 450 ends the backup process (S1080). The element file is saved when the virtual file is subjected to backup.

If the result of determination of step S1035 is negative (S1035: No), the backup program 450 extracts the metadata of the regular file being the target of backup from the metadata management table 600, and rewrites the management information (inode number) unique to the unified storage system 100 to the management information (UUID) of the backup server 160 (S1045).

The backup program 450 saves the converted metadata and the regular file in the backup server 160, sets the update flag 609 of the regular file to off (S1070), and ends the backup process (S1080).

If the determination result of step S1020 is positive (S1020: Yes), the backup program 450 acquires the virtual file configuration information 800 corresponding to the virtual file of the backup target from the unified storage system 100 (S1030).

The backup program 450 saves the element file in which the update flag 609 is set to on to the backup server 160 from the element files shown in the virtual file configuration information 800, and sets the update flag 609 of the element file to off (S1040).

The backup program 450 acquires the metadata of the element file and the backup target virtual file from the metadata management table 600, and rewrites the management information unique to the unified storage system 100 (inode number) to the management information (UUID) of the backup server 160. Further, the program rewrites the management information (inode number) unique to the unified storage system 100 of the virtual file configuration information 800 to a management information (UUID) of the backup server 160, and creates a converted virtual file configuration information 900 (S1050).

The backup program 450 saves the converted metadata or the converted virtual file configuration information 900 created in step S1050 and the difference data stored in the virtual file to the backup server 160 (S1060), and ends the backup processing (S1080).

If there are multiple backup target files as a result of extracting backup targets in step S1010, steps S1020 through S1070 are repeated corresponding to the number of backup target files. As described, the backup processing is completed via steps S1000 through S1080.

In steps S1020 through S1070, the backup program 450 executes conversion processing of metadata of the backup target file (virtual file, element file and regular file), and saves the converted metadata in the backup server 160. The set of converted metadata saved in the backup server 160 constitute the converted metadata management table 700.

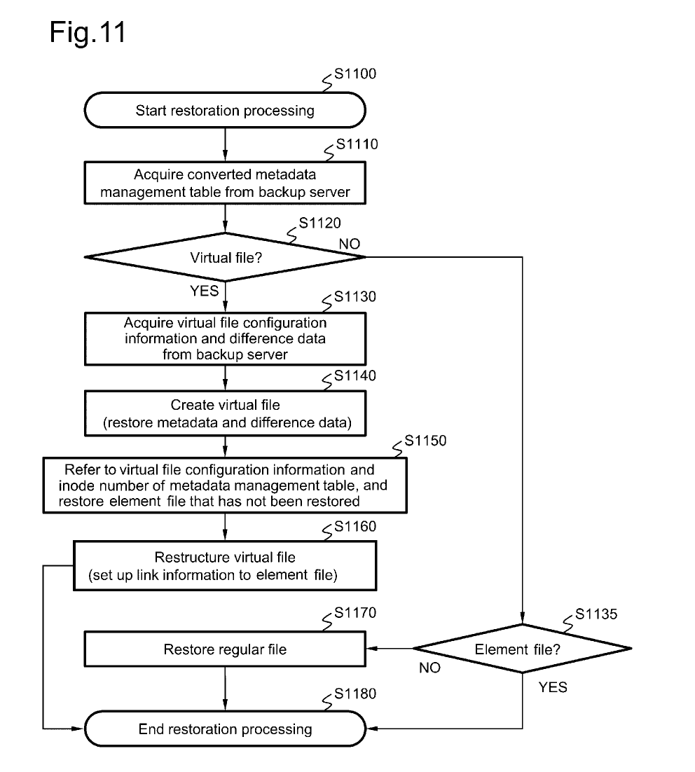

FIG. 11 is a flowchart of the restoration processing. If an instruction from a management computer 130 is received, the restoration program 460 starts a restoration processing accompanying the UUID list of the restoration target file (S1100).

The restoration program 460 acquires the converted metadata management table 700 saving the metadata of the restoration target file from the backup server 160 using the UUID of the restoration target file as the key (S1110).

The restoration program 460 refers to the type 607 of the converted metadata management table 700, and determines whether the restoration target file is a virtual file or not (S1120).

If the result of step 1120 is negative (the restoration target file is not a virtual file) (S1120: No), the restoration program 460 determines whether the restoration target file is an element file or not (S1135).

If the result of step S1135 is positive (the restoration target file is an element file) (S1135: Yes), the restoration program 460 ends the restoration processing (S1180). Since the restoration of the element file is performed in continuation of the restoration of the virtual file, nothing is performed here.

If the result of step S1135 is negative (the restoration target file is a regular file) (S1135: No), the restoration program 460 acquires a file (regular file) from the backup server 160. A new inode number unique within the unified storage system 100 is allocated to the restored file. The newly allocated inode number 601, a file name 602 acquired from the converted metadata management table 700, a size 603, a time stamp 604, an owner 605, an access control information 606, and a type 607 are saved in the metadata management table 600 as metadata of the restored file. Further, the update flag 609 is set to off (S1170). After setting of metadata is completed, the restoration processing is ended (S1180).

If the result of step S1120 is positive (the restoration target file is a virtual file) (S1120: Yes), the restoration program 460 acquires a converted virtual file configuration information 900 of the restoration target virtual file and the difference data from the backup server 160 (S1130).

The restoration program 460 creates a virtual file using the metadata of the virtual file acquired in step S1110 (converted metadata management table 700) and the difference data acquired in step S1130. A new inode number unique within the unified storage system 100 is allocated to the created virtual file. The newly allocated inode number 601, a file name 602 acquired from the converted metadata management table 700, a size 603, a time stamp 604, an owner 605, an access control information 606, and a type 607 are saved in the metadata management table 600 as metadata of the created virtual file. Further, the update flag 609 is set to off (S1140).

The restoration program 460 searches and confirms the file name 602 of the metadata management table 600 whether the element file having file name 802 stored in the converted virtual file configuration information 900 is already restored in the unified storage system 100 or not. If restoration is not yet performed, the data of the corresponding element file is acquired from the backup server 160 using the UUID 901 as the key, and restores the same in the unified storage system 100. A new inode number unique within the unified storage system 100 is allocated to the restored element file. The newly allocated inode number 601, a file name 602 acquired from the converted metadata management table 700, a size 603, a time stamp 604, an owner 605, an access control information 606, and a type 607 are saved in the metadata management table 600 as metadata of the restored element file. Further, the update flag 609 is set to off (S1150).

The restoration program 460 performs restructure processing of the virtual file (S1160). In other words, the management information (UUID) of the backup server 160 within the virtual file configuration information 900 acquired from the backup server 160 is rewritten with the information of the element file restored in the unified storage system 100 (management information (inode number) of the unified storage system 100), and creates a virtual file configuration information 800. The restructuring of the virtual file is completed by saving the created virtual file configuration information 800 in the configuration information 608 of metadata created in step S1140.

After restructuring the virtual file, the restoration program 460 completes the restoration processing (S1180).

If there are multiple restoration target files in the instruction received from the management computer 130, steps S1110 through S1170 are repeated corresponding to the number of restoration target files. The restoration processing is completed by the above-described steps S1100 through S1180.

In the above-illustrated embodiment, the element file is shared among multiple virtual files, so that when a virtual file is subjected to backup or restoration, it is possible that the element file is already subjected to backup or restoration. Therefore, the present invention confirms in advance the state of the update flag 609 of the metadata management table 600 or whether the file is already stored in the metadata management table 600 so as to cut down unnecessary backup and restoration processes.

As described, by saving the virtual file configuration information when creating a backup of the virtual file, it is possible to restore the data subjected to backup as a virtual file. Further, upon subjecting a virtual machine disk image or a database file having a relatively large capacity to backup or restoration processes, the capacity efficiency of the unified storage system 100 or the backup server 160 can be improved. Further, since unnecessary backup and restoration operations can be suppressed, deterioration of system performance can be prevented.

### Embodiment 2

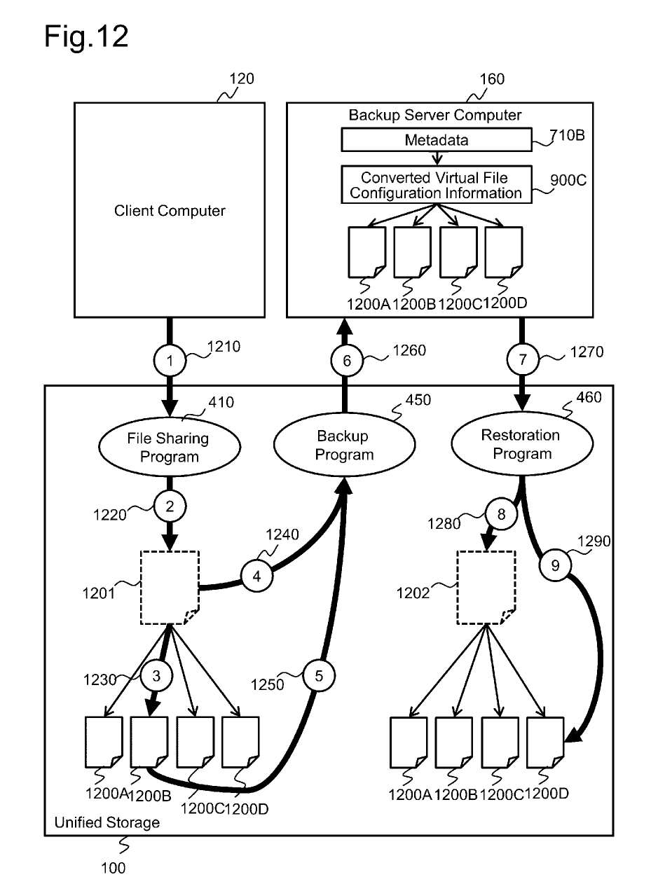

FIG. 12 is a schematic diagram showing an outline of a second embodiment of the present invention. FIG. 12 shows an outline of backup and restoration of a virtual file 1201 shared via the file sharing program 410. Now, the virtual file 1201 is a virtual file having four files, 1200A, 1200B, 1200C and 1200D, as element files.

An actual data of the virtual file 1201 is divided into multiple element files and saved. When an I/O request to a virtual file 1201 occurs, the I/O request is transferred to an element file managing the actual data.

With reference to FIG. 12, the flow starting from the I/O related to the virtual file 1201 to backup and restoration will be described below.

(1) When an I/O request using a file-level communication protocol (NFS/CIFS/FTP/HTTP) or the like occurs from a client 120, the file sharing program 410 receives the I/O request (1210).

(2) The file sharing program 410 performs I/O processing with respect to the virtual file 1201 in the file system based on the I/O request from the client 120 (1220).

(3) The file sharing program 410 determines based on the offset of the I/O request which element file manages the actual data for which the I/O is received, and issues an I/O to the corresponding element file. In FIG. 12, the I/O is issued to element file 1200B (1230).

(4) The backup program 450 periodically monitors update of metadata (such as the file name, the file size, the owner and the access control information) of the virtual file 1201. When update is detected, the backup program 450 acquires the metadata of the file 1201 and the virtual file configuration information 800 managed by the unified storage system 100 (1240).

(5) The backup program 450 periodically monitors data update of element files 1200A through 1200D. When update of data is detected, the backup program 450 acquires the data of the updated element file. In FIG. 12, file 1200B is denoted as the updated element file (1250).

(6) The backup program 450 backs up the metadata and the virtual file configuration information of the virtual file 1201 acquired in (4) and the data of the updated element file 1200B acquired in (5) to the backup server 160. At this time, the management information (such as the inode number) unique to the unified storage system 100 from the metadata and the virtual file configuration information acquired in (4) is converted to a management information of the backup server 160 (such as the UUID), and the converted metadata or the virtual file configuration information are backed up (1260).

Within the backup server 160 of FIG. 12, the metadata 710B of the virtual file 1201 and the converted virtual file configuration information 900C are associated and saved, wherein the converted virtual file configuration information 900C retains a pointer to actual data of the virtual file (element files 1200A through 1200D) as the UUID.

(7) Upon receiving the restoration instruction via a management computer 130 or the like, the restoration program 460 performs reading of the metadata and the virtual file configuration information of the restoration target file from the backup server 160. At this time, the management computer 130 instructs restoration of the virtual file 1201. The restoration program 460 reads the metadata 710B and the converted virtual file configuration information 900C of the virtual file 1201 (1270).

(8) The restoration program 460 restores an empty virtual file 1202 in which only metadata is set using the metadata 710B of the virtual file 1201. According to the actual restoration processing, the management identifier UUID of metadata acquired in (7) is rewritten to a management information unique to the unified storage system 100 (inode number), and saved in the memory 202 of the unified storage system 100 (1280).

(9) The restoration program 460 downloads actual data (element files 1200A through 1200D) from the backup server 160 using the UUID retained in the virtual file configuration information acquired in (7) as the key, and instructs the restoration processing of the corresponding relationship of the virtual file 1202 and element files 1200A through 1200D to the unified storage system 100.

According to the actual restoration processing, the UUID of the virtual file configuration information acquired in (7) is rewritten to the management information unique to the unified storage system 100 (inode number) and stored in the memory 202 of the unified storage system 100 (1290).

In (4) and (5), the backup program 450 periodically monitors element files and virtual files to detect update, but the method for detecting update is not restricted thereto. For example, it is possible to have the file sharing program 410 notify the backup program 450 when the file sharing program 410 updates a virtual file.

In (9), a method is illustrated in which the restoration program 460 reads the data of the virtual file 1201 and element files 1200A through 1200D at once to perform restoration, but the restoration method is not restricted thereto.

For example, it is possible to adopt a system (On Demand Restore) in which the data of the necessary section (element file) is read and restored based on the I/O request sent from the user to the virtual file, instead of reading the data to be restored at once.

In FIG. 12, the I/O request using a file-level communication protocol such as NFS/CIFS/FTP/HTTP and the like sent from a client 120 is received by a file sharing program 410 and converted to the I/O of a file within the unified storage system 100, but the method for performing I/O of the unified storage system 100 is not restricted thereto.

For example, instead of the file sharing program 410, it is possible to receive the I/O request using a block-level communication protocol such as FC/FCoE/iSCSI and the like by the block-file I/O conversion program 420 and convert the I/O to an I/O of a file stored in the unified storage system 100.

As described in (1) through (9), by saving the virtual file configuration information when creating a backup of the virtual file, it becomes possible to restore the backup data as a virtual file.

In the following description, an example of a metadata management table, a metadata management table subjected to backup, a virtual file configuration table, and a virtual file configuration table subjected to backup according to the second embodiment of the present invention will be illustrated.

In the schematic diagram of FIG. 12, the transfer destination of the backup program 450 is the backup server 160 disposed outside the unified storage system 100, but the present invention is not restricted thereto. For example, the backup server 160 can be disposed within the unified storage system.

In the schematic diagram of FIG. 12, only the corresponding relationship between the virtual file 1202 and element files 1200A through 1200D have been illustrated, but it is possible to adopt a file configuration in which any one of element files 1200A through 1200D (for example, the element file 1200C) functions as a virtual file, and the virtual file is composed of a plurality of element files. In other words, the backup and restoration method according to the present invention can also be applied to tiered virtual files.

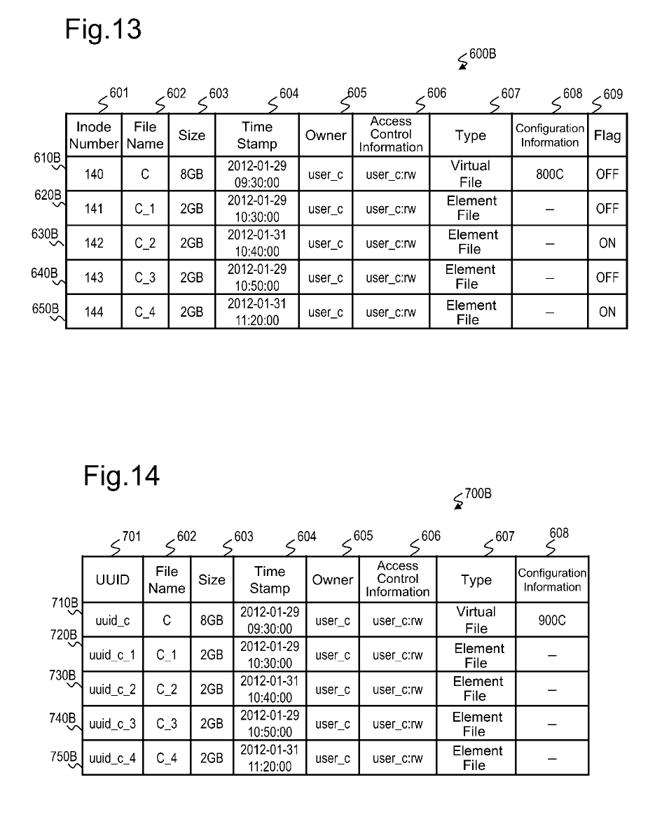

FIG. 13 illustrates a configuration example of a metadata management table according to the second embodiment. The meaning of each row is equivalent to FIG. 6, so the description thereof is omitted. The metadata management table 600B manages metadata having a single virtual file having a file name “C” and four element files “C_1”, “C_2”, “C_3” and “C_4”. Incidentally, 610B corresponds to the metadata of virtual file 1201 in FIG. 12, and 620B through 650B each correspond to the metadata of element files 1200A through 1200D in FIG. 12.

FIG. 14 is an example of a metadata management table backed up in the backup server 160 according to the second embodiment. The meaning of each row is equivalent to FIG. 7, so the description thereof is omitted. A UUID 701 is an ID for uniquely managing the unit of backup data (files and objects) within the backup server 160. For example, in the first row 710B of the converted metadata management table 700B, “uuid_c” is stored as UUID instead of the management information inode number unique to the unified storage stored in 600B.

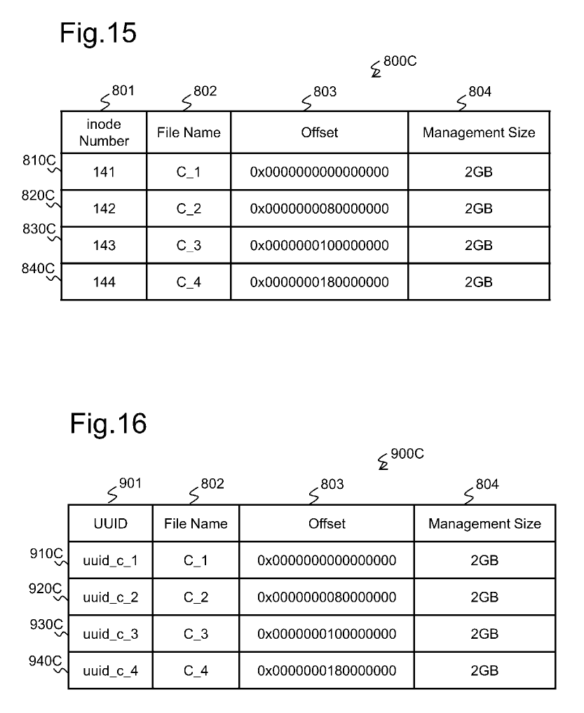

FIG. 15 shows an example of a virtual file configuration table according to a second embodiment of the present invention. The meaning of each row is equivalent to that of FIG. 8, so the description thereof is omitted. A virtual file configuration information 800C manages the information on virtual file C and related files.

FIG. 16 shows an example of a virtual file configuration table subjected to backup in the backup server 160 according to the second embodiment. The meaning of each row is equivalent to that of FIG. 9, so the description thereof is omitted. A UUID 901 is an ID for uniquely managing the backup data units (files and objects) within the backup server 160.

For example, in the first row 910C of the converted virtual file configuration information 900C, “uuid_c_1” is retained as UUID instead of the management information inode number unique to a unified storage retained in 800C. Similarly, “uuid_c_2” and so on are retained in the following rows. In FIGS. 15 and 16, the management size of each file is 2 GB, but the present invention is not restricted thereto, and the size can be set arbitrarily. Further, in FIGS. 8 and 9, files having the offset set to “others” can be managed as a single element file in the virtual file configuration information.

As described according to embodiment 2, similar to embodiment 1, by saving the virtual file configuration information during backup of the virtual file, it becomes possible to restore the backed up data as a virtual file instantly, and to further improve the capacity efficiency effectively.

The present embodiments have been described, but the embodiments are merely illustrated for better understanding of the present invention, and are not intended to restrict the scope of the present invention in any manner The present invention can be realized in various other ways.

A portion of a configuration of a certain embodiment can be replaced with a configuration of another embodiment, or a configuration of a certain embodiment can be added to the configuration of another embodiment. In addition, another configuration can be added to, deleted from or replaced with a portion of the configuration of each embodiment.

Further, a portion or all of each configuration, function, processing unit and processing means in the present description can be realized via a hardware such as the design of an integrated circuit. Moreover, each configuration, function and the like mentioned above can be realized via a software capable of interpreting the program for realizing the respective functions and executing the program.

The information such as the programs, tables and files for realizing the respective functions can be stored in a memory device such as a memory, a hard disk or a SSD (Solid State Drive), or in a memory media such as an IC card, an SD card or a DVD.

The control lines and information lines illustrated in the drawings are merely illustrated for sake of explanation, and not necessary all the control lines and information lines required for manufacture are illustrated. Actually, substantially all the components can be considered to be mutually connected.

### INDUSTRIAL APPLICABILITY

The present invention can be applied to information processing devices such as general-purpose computers and servers, and to storage devices such as storage systems.

### REFERENCE SIGNS LIST

100 Unified storage system

110 Host computer

120 Client computer

130 Management computer

140 SAN (Storage Area Network) 150 LAN (Local Area Network)

160 Backup server computer

200 Storage head

201 CPU

202 Memory

203, 204 HBA (Host Bus Adaptor)

205 NIC (Network Interface Card)

210 Storage device

211 Storage cache

212 Storage controller

213 SSD (Solid State Disk)

214 SAS (Serial Attached SCSI) disk

215 SATA (Serial ATA) disk

220 Communication path

301 CPU

302 Memory

303 Input device

304 NIC

305 Secondary storage device

306 Display device

410 File sharing program

420 Block-file I/O conversion program

430 Virtual file creation program

450 Backup program

460 Restoration program

500 File

501, 502, 503 Virtual file

590A, 590B, 590C, 590D Data area (Extent)

591A, 591C Extent

600, 600A, 600B Metadata management table

601 Inode number

602 File name

603 File size

604 Time stamp

605 Owner

606 Access control information

607 Type

608 Configuration information

609 Flag

700A, 700B Converted metadata management table

701 UUID

710A, 710B, 720A Metadata

800, 800A, 800B, 800C Virtual file configuration information

900, 900A, 900B, 900C Converted virtual file configuration information

801 Inode number

802 File name

803 Offset

804 Management size

901 UUID

1200A, 1200B, 1200C, 1200D Element file

1201, 1202 Virtual file

1. A storage system coupled to a host computer and a backup device, the storage system comprising a storage device storing a first file, and a second file having a difference data with the data of the first file and referring to the data in the first file except for the difference data; and a storage controller for managing the file storage in the storage device; wherein
a first identifier and a second identifier unique within the storage system are allocated to the first and second files;
a reference relationship information indicating the reference relationship between the first and second files is stored via the first and second identifiers in the storage device; and
upon executing backup processing of the second file, the storage controller converts the first and second identifiers in the reference relationship information to a third identifier and a fourth identifier unique within the backup device, and performs backup of the reference relationship information including the converted third and fourth identifiers, the data of the first file, and the difference data.

2. The storage system according to claim 1, wherein the backup of the second file to the backup device is executed by updating the first file.

3. The storage system according to claim 2, wherein the reference relationship information has a control information for controlling the backup processing of the second file to the backup device, and the backup of the second file to the backup device is executed based on the control information.

4. The storage system according to claim 1, wherein if the first file is not a virtual file, the conversion of the identifier and management information is not executed, and the backup of the first file to the backup device is executed.

5. The storage system according to claim 1, wherein the backup of the second file to the backup device is performed by subjecting only the updated section with respect to the first file to backup.

6. The storage system according to claim 1, wherein the restoration of the second file of the backup device to the storage system is performed by subjecting only a portion of the second file to restoration.

7. A method for controlling backup and restoration of a storage system comprising a first file, and a second file having a difference data with the data of the first file and referring to the data in the first file except for the difference data, the storage system being coupled to a backup device; the method comprising:
allocating a first identifier and a second identifier unique within the storage system to the first and the second files;
storing a reference relationship information indicating the reference relationship between the first and second files via the first and second identifiers in the storage device; and
upon executing backup processing of the second file, converting the first and second identifiers in the reference relationship information to a third identifier and a fourth identifier unique within the backup device, and performing backup of the reference relationship information including the converted third and fourth identifiers, the data of the first file, and the difference data.

8. The method for controlling backup and restoration according to claim 7, wherein the backup of the second file to the backup device is executed by updating the first file.

9. The method for controlling backup and restoration according to claim 8, wherein the reference relationship information has a control information for controlling the backup processing of the second file to the backup device, and the backup of the second file to the backup device is executed based on the control information.

10. The method for controlling backup and restoration according to claim 7, wherein if the first file is not a virtual file, the conversion of the identifier and management information is not executed, and the backup of the first file to the backup device is executed.

11. The method for controlling backup and restoration according to claim 7, wherein the backup of the second file to the backup device is performed by subjecting only the updated section with respect to the first file to backup.

12. The method for controlling backup and restoration according to claim 7, wherein the restoration of the second file of the backup device to the storage system is performed by subjecting only a portion of the second file to restoration.
